(19) United States
(12) Patent Application Publication
(10) Pub. No.: US 2025/0141139 A1
(43) Pub. Date: May 1, 2025

(54) CONNECTOR DEVICE

(71) Applicant: YAZAKI CORPORATION, Tokyo (JP)

(72) Inventors: Akira Shinchi, Makinohara-shi (JP); Toshiharu Takahashi, Makinohara-shi (JP)

(21) Appl. No.: 19/008,615

(22) Filed: Jan. 2, 2025

Related U.S. Application Data
(63) Continuation of application No. PCT/JP2023/040527, filed on Nov. 10, 2023.

(30) Foreign Application Priority Data
Nov. 30, 2022 (JP) 2022-190945

(51) Int. Cl. H01R 12/81; H01R 13/639

(52) U.S. Cl. CPC H01R 12/81; H01R 13/639

(57) ABSTRACT

A connector device includes a first connector attached to a flexible substrate, and a second connector that holds a plurality of terminals attached to a plurality of electric wires, configured to be connectable to the first connector, and connected to the first connector to connect the electric wires and the flexible substrate via the terminals. The second connector has a protruding portion protruding and extending in a connection direction. The first connector has an accommodation portion into which the protruding portion can be inserted and accommodated and that guides connection between the first connector and the second connector by the insertion of the protruding portion. The accommodation portion has a tapered portion that tapers toward the inner side of the accommodation portion.

### CROSS-REFERENCE TO RELATED APPLICATION

This application is a continuation application of International Application No. PCT/JP2023/040527 filed on Nov. 10, 2023 which claims the benefit of priority from Japanese Patent Application No. 2022-190945 filed on Nov. 30, 2022 and designating the U.S., the entire contents of which are incorporated herein by reference.

### BACKGROUND OF THE INVENTION

### 1. Field of the Invention

The present invention relates to a connector device.

### 2. Description of the Related Art

Conventionally, connector devices are known, including a connector in which female terminals are attached to flexible printed circuits (FPC) and held in a housing as described in Japanese Patent Application Laid-open No. 2004-206992, for example. This connector is used, for example, by being connected to a mating connector in which male terminals are attached to electric wires. In a connector device composed of the connector and the mating connector, the male terminal attached to the electric wire is connected to the flexible printed circuits via the female terminal attached to the flexible printed circuits.

### SUMMARY OF THE INVENTION

An object of the present invention is to provide a connector device that enables proper and smooth connection between a flat circuit body and an electric wire.

In order to achieve the above mentioned object, a connector device according to one aspect of the present invention includes: a first connector attached to a flat circuit body; and a second connector that holds a plurality of terminals attached to a plurality of electric wires, configured to be connectable to the first connector, and connected to the first connector to connect the electric wires and the flat circuit body via the terminals, wherein one of the first connector and the second connector has a protruding portion protruding and extending in a connection direction between the first connector and the second connector, an other of the first connector and the second connector has an accommodation portion into which the protruding portion is capable of being inserted and accommodated and that guides connection between the first connector and the second connector by insertion of the protruding portion, and at least one of the protruding portion and the accommodation portion has a tapered portion that tapers toward an inner side of the accommodation portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a connector device according to an embodiment;

FIG. 2 is an exploded perspective view of a first connector of the connector device according to the embodiment;

FIG. 3 is an exploded perspective view of the first connector of the connector device according to the embodiment;

FIG. 4 is an exploded perspective view of a second connector of the connector device according to the embodiment;

FIG. 5 is a perspective view of a terminal of the connector device according to the embodiment;

FIG. 6 is a view for explaining the connection of the connector device according to the embodiment;

FIG. 7 is a view for explaining the connection of the connector device according to the embodiment; and

FIG. 8 is a sectional view of a connected state of the connector device according to the embodiment along line VIII-VIII of FIG. 1.

### DETAILED DESCRIPTION OF THE PREFERRED EMBODIMENTS

Embodiments according to the present invention are described below in greater detail based on the drawings. The present invention is not limited by the embodiments. Components in the embodiments below include components substitutable and easily substituted by those skilled in the art or components substantially identical therewith.

### Embodiments

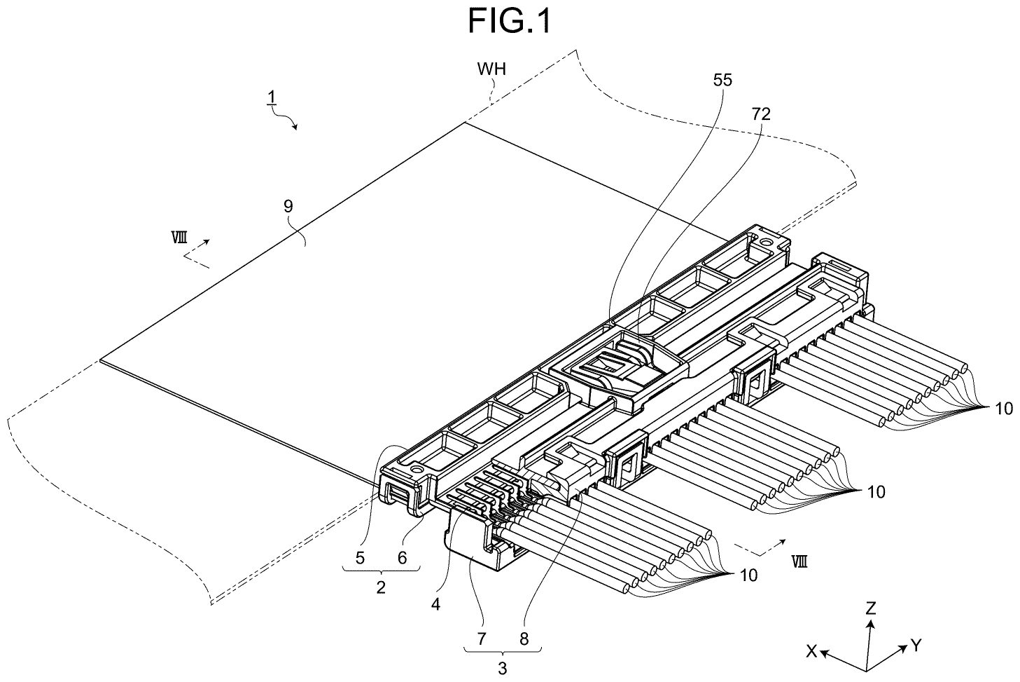

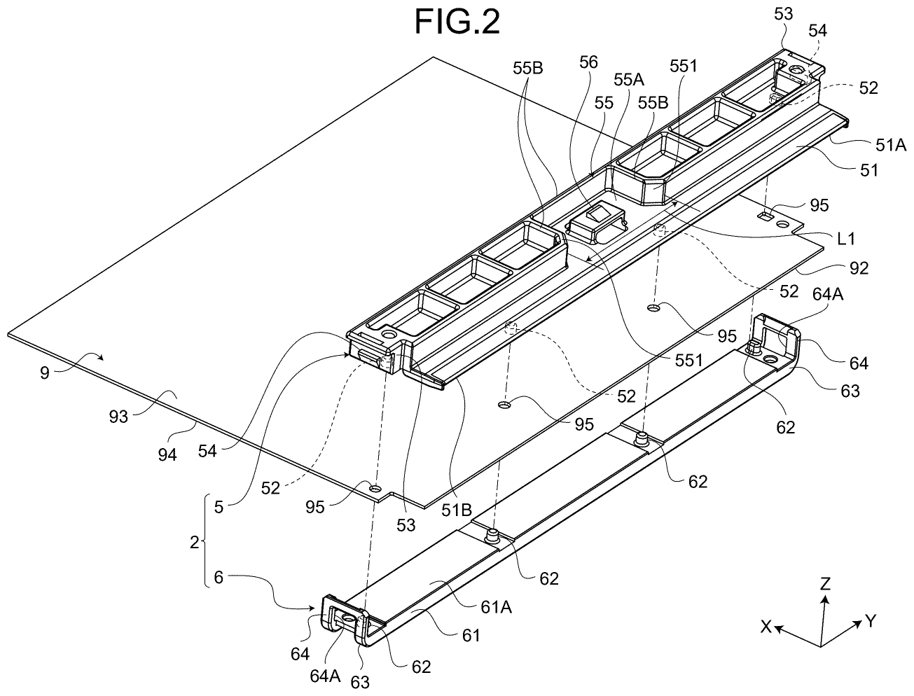

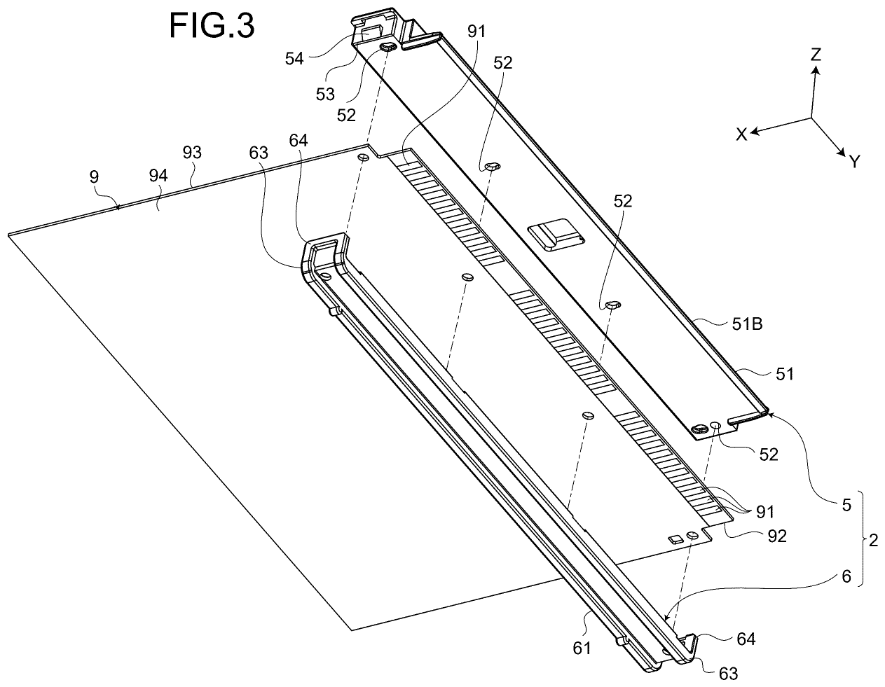

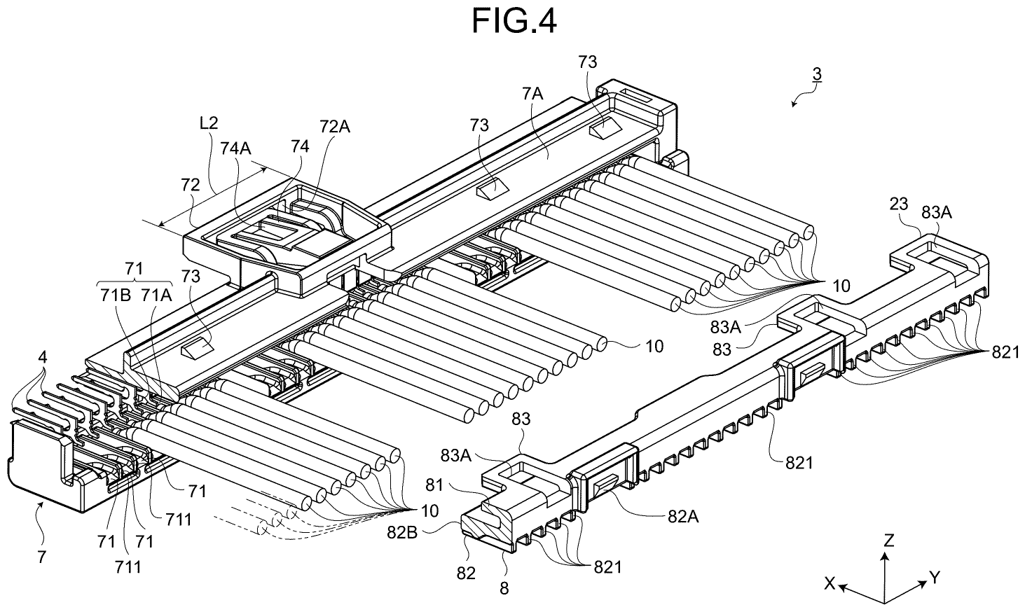

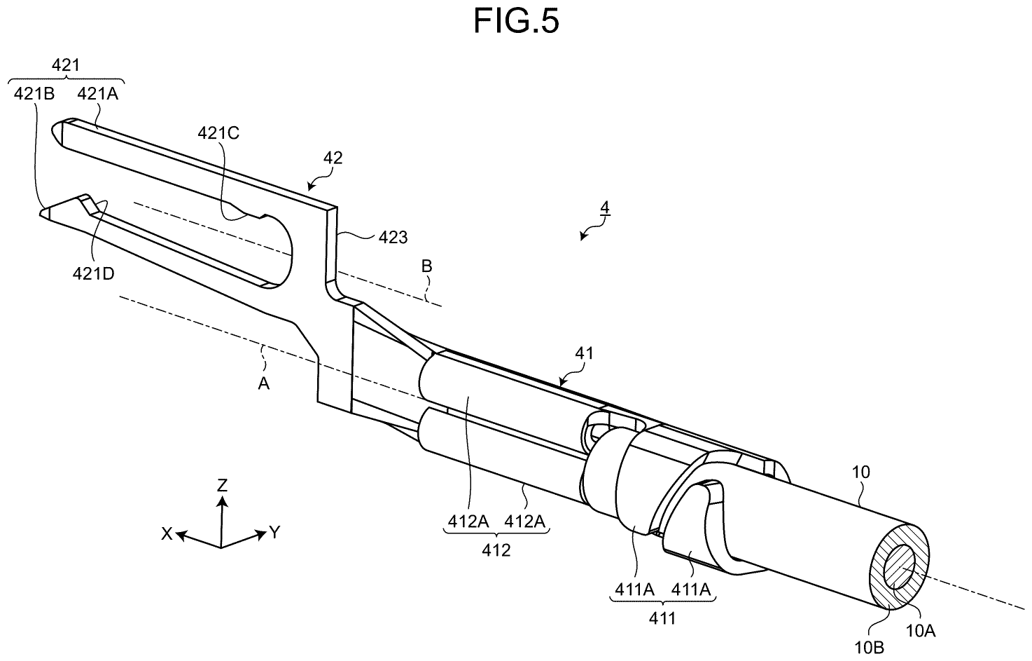

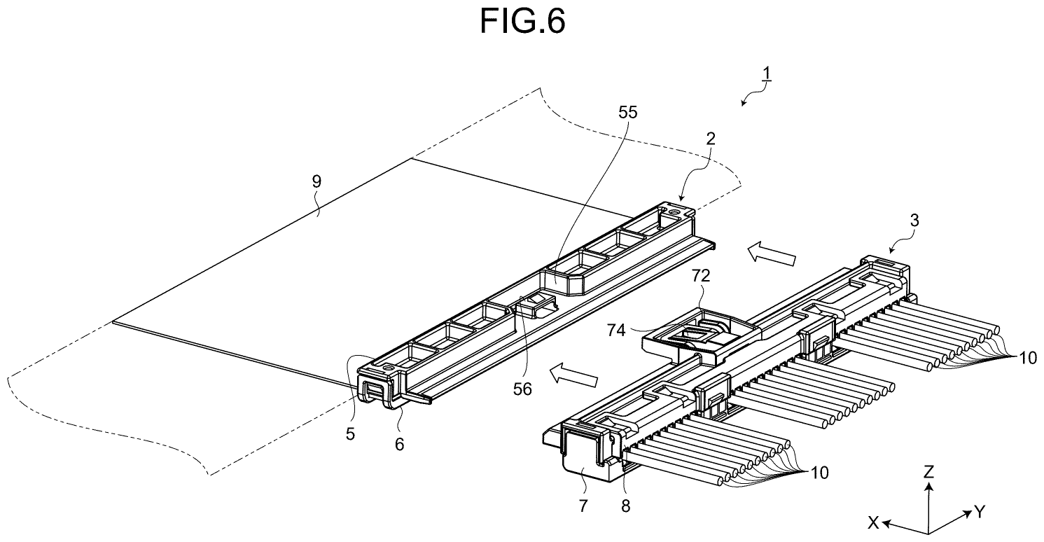

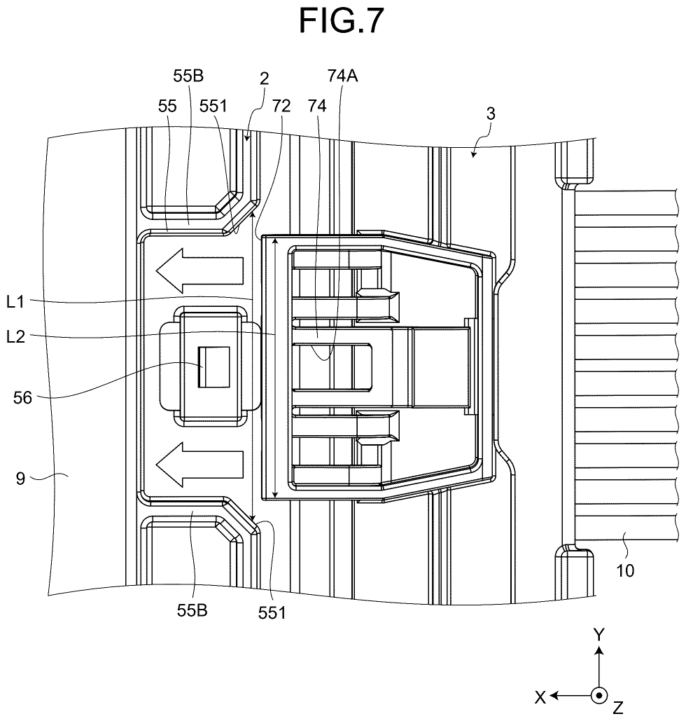

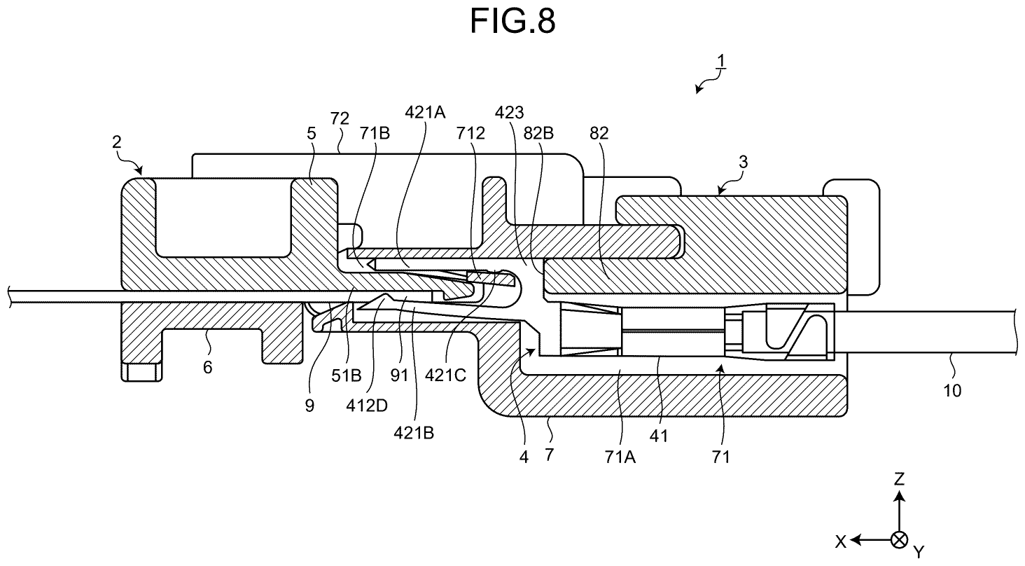

The present embodiment relates to a connector device. FIG. 1 is a perspective view of the connector device according to the embodiment. FIGS. 2 and 3 are exploded perspective views of a first connector of the connector device according to the embodiment. FIG. 4 is an exploded perspective view of a second connector of the connector device according to the embodiment. FIG. 5 is a perspective view of a terminal of the connector device according to the embodiment. FIGS. 6 and 7 are views for explaining the connection of the connector device according to the embodiment. FIG. 8 is a sectional view of a connected state of the connector device according to the embodiment along line VIII-VIII of FIG. 1.

In the following description, a first direction, a second direction, and a third direction intersecting one another are denoted as follows: the first direction is referred to as a “connection direction X”, the second direction is referred to as a “width direction Y,” and the third direction is referred to as a “height direction Z”. The connection direction X, the width direction Y, and the height direction Z are orthogonal to one another. The connection direction X corresponds to the direction of connection between the first connector and the second connector or the extending direction of an electric wire. The width direction Y and the height direction Z correspond to intersecting directions that intersect the connection direction X. Unless otherwise noted, each direction used in the following description represents the direction in a state where the parts are assembled with one another. Note that being orthogonal herein includes being substantially orthogonal.

As illustrated in FIG. 1, a connector device 1 is a device that connects a flexible substrate 9 and electric wires 10. The connector device 1 is used by being mounted on a vehicle, for example, and is used as a wire harness WH that connects electrical equipment installed in the vehicle. Examples of the electrical equipment include, but are not limited to, electronic control devices, sensors, circuit devices, motors, batteries, etc. For example, the flexible substrate 9 is used as a main line part of the wire harness WH, and the electric wire 10 is used as a branch line part of the wire harness WH.

The connector device 1 includes a first connector 2, a second connector 3, and terminals 4. FIG. 1 illustrates the connector device 1 with the first connector 2 and the second connector 3 connected and illustrates a state where part of the second connector 3 is cut out for convenience of explanation.

The first connector 2 is a connector attached to the flexible substrate 9 and is configured connectable to the second connector 3. The flexible substrate 9 is a flat circuit body in which circuits are planarly configured and is a flexible printed wiring board called flexible printed circuits (FPC). Being flat herein includes being substantially flat. The flexible substrate 9 is formed, for example, by laminating a base film, a conductor foil, and a coverlay with an adhesive layer interposed therebetween. The conductor foil is a wiring pattern of the flexible substrate 9 and serves as wiring portions 91 of the flexible substrate 9. The flexible substrate 9 may be a single-sided substrate with the wiring pattern on only one surface of the base film or a double-sided substrate with the wiring pattern on both surfaces of the base film. The flexible substrate 9 may or may not be provided with electrical components, such as resistors and capacitors, on the wiring pattern.

As illustrated in FIG. 2, the first connector 2 includes a first housing 5 and a first cover 6 and is attached to an end 92 of the flexible substrate 9, for example. Specifically, the first connector 2 is attached to the flexible substrate 9 by joining the first housing 5 and the first cover 6 with the flexible substrate 9 sandwiched therebetween. The first housing 5 is a member that mates with the first cover 6 to hold the flexible substrate 9 and is connected to the second connector 3. The first housing 5 has a plate-shaped housing body 51 extending in the width direction Y and is disposed on a surface 93 of the flexible substrate 9. The first cover 6 is a member that mates with the first housing 5 to sandwich and hold the flexible substrate 9. The first cover 6 has a plate-shaped cover body 61 extending in the width direction Y and is disposed on a back surface 94 of the flexible substrate 9.

An installation surface 61A of the first cover 6 is provided with protrusions 62. The installation surface 61A is a surface of the cover body 61 that faces the flexible substrate 9 and sandwiches the flexible substrate 9 between it and the first housing 5. The protrusion 62 protrudes from the installation surface 61A toward the back surface 94 of the flexible substrate 9. The protruding length of the protrusion 62 is set longer than the thickness of the flexible substrate 9. A plurality of protrusions 62 are provided: one at each of ends 63 of the first cover 6 in the width direction Y, and two at intermediate positions between the ends 63, for example. The flexible substrate 9 has through holes 95. The through hole 95 is a hole passing through the surface 93 and the back surface 94. A plurality of through holes 95 are formed at positions corresponding to the protrusions 62. an installation surface 51A of the first housing 5 has recesses 52. The installation surface 51A is a surface of the housing body 51 that faces the flexible substrate 9 and sandwiches the flexible substrate 9 between it and the first cover 6. The recess 52 is formed by recessing the installation surface 51A and has such a size that it allows the protrusion 62 to be inserted thereinto. A plurality of recesses 52 are formed at positions corresponding to the protrusions 62.

The end 63 of the first cover 6 has an engaging portion 64, and an end 53 of the first housing 5 has an engaged portion 54. The engaging portion 64 and the engaged portion 54 constitute a locking mechanism that locks the first cover 6 and the first housing 5. For example, the engaged portion 54 is a protrusion protruding laterally from the side surface of the first housing 5, and the engaging portion 64 extends from the end 63 of the first cover 6 toward the first housing 5 to form a hole 64A into which the engaged portion 54 can be inserted.

To attach the first cover 6 and the first housing 5 to the flexible substrate 9, the first cover 6 is first disposed on the back surface 94 of the flexible substrate 9, and the protrusions 62 are inserted into the through holes 95. The protrusions 62 pass through the through holes 95 and protrude from the surface 93. The protrusions 62 protruding from the surface 93 of the flexible substrate 9 are inserted into the recesses 52, and thus the first housing 5 is disposed. As a result, the first cover 6 and the first housing 5 are disposed at the correct position with respect to the flexible substrate 9. In other words, in the flexible substrate 9, the first cover 6, and the first housing 5, the through holes 95, the protrusions 62, and the recesses 52 function as positioning portions and portions that prevent the flexible substrate 9 from coming off between the first cover 6 and the first housing 5.

The engaging portions 64 of the first cover 6 engage with the engaged portions 54 of the first housing 5, and the first housing 5 and the first cover 6 are joined such that they are not easily disengaged. As a result, the first cover 6 and the first housing 5 are joined with the flexible substrate 9 sandwiched therebetween, and the first cover 6 and the first housing 5 are attached to the flexible substrate 9.

The first housing 5 has an accommodation portion 55. The accommodation portion 55 is a portion into which a protruding portion 72 of the second connector 3 is inserted and defines an accommodation space 55A for the protruding portion 72. For example, the accommodation portion 55 is formed by a wall 55B provided to the housing body 51. The wall 55B is provided along the connection direction X with an opening on the second connector 3 side (lower right side in FIG. 2). The length of the accommodation space 55A in the width direction Y is equal or substantially equal to the length of the protruding portion 72 in the width direction Y. When the protruding portion 72 is inserted into the accommodation portion 55, the first connector 2 and the second connector 3 are accurately connected, and the terminals 4 come into contact with the desired wiring portions 91. The length of the accommodation space 55A in the connection direction X is such a length that it can prevent the first connector 2 and the second connector 3 from being obliquely connected. Therefore, the connector device 1 can prevent the first connector 2 and the second connector 3 from being obliquely fit and connected.

The accommodation portion 55 has a tapered portion 551. The tapered portion 551 is formed such that the accommodation portion 55 tapers toward the inner side of the accommodation portion 55. In other words, the tapered portion 551 functions as a portion that facilitates insertion of the protruding portion 72 into the accommodation portion 55. For example, the tapered portion 551 is formed such that the length LI of the accommodation space 55A in the width direction Y is wider than the length L2 of the protruding portion 72 in the width direction Y at the entrance of the accommodation portion 55 and that the length L1 of the accommodation space 55A in the width direction Y becomes narrower than the length L2 of the protruding portion 72 in the width direction Y as closer to the inner side of the accommodation portion 55. This tapered portion 551 is formed at the left and right positions in the width direction Y at the entrance of the accommodation portion 55, for example. In the connector device 1, the tapered portion 551 facilitates insertion of the protruding portion 72 into the accommodation portion 55, and the first connector 2 and the second connector 3 can be smoothly connected. In particular, if the clearance between the accommodation space 55A of the accommodation portion 55 and the protruding portion 72 is small, the first connector 2 and the second connector 3 are easily connected.

One accommodation portion 55 is formed at the center position in the width direction Y of the first housing 5, for example. Alternatively, a plurality of accommodation portions 55 may be formed at positions spaced apart in the width direction Y of the first housing 5. The accommodation portion 55 is provided with a locked portion 56. The locked portion 56 is a portion that engages with a locking portion 74 of the second connector 3 and is used to lock the first connector 2 and the second connector 3 when they are connected. The locked portion 56 is provided inside the accommodation portion 55. In other words, the locked portion 56 is formed to be surrounded by the wall 55B of the accommodation portion 55 and protected by the accommodation portion 55. The locked portion 56 is a protrusion protruding toward the height direction z, for example. The locked portion 56 is locked by the locking portion 74 and functions as a locking mechanism of the first connector 2 and the second connector 3.

As illustrated in FIG. 3, the flexible substrate 9 includes the wiring portions 91. The wiring portion 91 is a portion serving as a contact point for electrical connection of the flexible substrate 9 and is part of the wiring pattern. At the position of the wiring portion 91, the coverlay for surface protection is removed, and the conductor foil is exposed. The wiring portion 91 is subjected to surface treatment to prevent oxidation of the conductor foil, for example. A plurality of wiring portions 91 are arrayed along the width direction Y at the end 92 of the back surface 94 of the flexible substrate 9, for example. The number of wiring portions 91 is set corresponding to the number of terminals 4 of the second connector 3, for example. The end 92 of the flexible substrate 9 at which the wiring portions 91 are formed is disposed adjacently to a connection insertion portion 51B of the first housing 5. The connection insertion portion 51B is part of the housing body 51 of the first housing 5 and is a plate-like portion protruding toward the second connector 3 along the connection direction X.

As illustrated in FIG. 4, the second connector 3 is a connector connected to the first connector 2 to electrically connect the terminal 4 to the wiring portion 91 of the flexible substrate 9. In other words, the second connector 3 holds the terminal 4 and is configured to be connectable to the first connector 2. The second connector 3 is connected to the first connector 2 to bring the terminal 4 into direct contact with the wiring portion 91 of the flexible substrate 9 and connect the terminal 4 to the wiring portion 91.

The second connector 3 includes a second housing 7 and a second cover 8. FIG. 4 illustrates a state where part of the second housing 7 and the second cover 8 is cut out and do not illustrate some of the electric wires 10 for convenience of explanation. The second housing 7 is a member that holds the terminal 4 attached to the electric wire 10, and the second cover 8 is a member that is attached to the second housing 7 to hold the electric wire 10 and prevents the terminal 4 from coming off.

The second housing 7 is a member that holds the terminal 4 attached to the electric wire 10 and is formed in a block shape, for example. The second housing 7 has an accommodation chamber 71 for accommodating the terminal 4 and the electric wire 10 and mates with the second cover 8 to hold the terminal 4. The second connector 3 can hold a plurality of terminals 4, and the second housing 7 has a plurality of accommodation chambers 71 arrayed along the width direction Y. The accommodation chamber 71 extends along the connection direction X and can accommodate the terminal 4 and the electric wire 10. This accommodation chamber 71 includes a first accommodation chamber 71A and a second accommodation chamber 71B. The first accommodation chamber 71A is a space for accommodating the electric wire 10, and the second accommodation chamber 71B is a space for accommodating the terminal 4. The second accommodation chamber 71B is formed closer to the first connector 2 than the first accommodation chamber 71A. The second accommodation chamber 71B is narrower in the width direction Y than the first accommodation chamber 71A. Therefore, the terminal 4 accommodated in the second accommodation chamber 71B is held such that its movement is restricted in the second accommodation chamber 71B. In other words, the terminal 4 is positioned and held with respect to the second connector 3 in the width direction Y and the height direction Z by being accommodated in the second accommodation chamber 71B.

The second accommodation chamber 71B is provided with a support 712 (refer to FIG. 8). The support 712 is a portion that supports a first contact piece 421A of the terminal 4, which will be described later. The support 712 is spaced apart from the inner surface of the second accommodation chamber 71B. The first contact piece 421A is accommodated in the second accommodation chamber 71B by passing between the inner surface of the second accommodation chamber 71B and the support 712. At this time, the first contact piece 421A is press-fit between the inner surface of the second accommodation chamber 71B and the support 712, and the terminal 4 is accommodated in the second accommodation chamber 71B. As a result, the terminal 4 is firmly held in the second accommodation chamber 71B. A protrusion 421C protruding in the height direction Z may be formed on the part of the first contact piece 421A positioned between the inner surface of the second accommodation chamber 71B and the support 712 (refer to FIGS. 5 and 8). With the protrusion 421C, the connector device 1 enables the first contact piece 421A to be smoothly accommodated in the second accommodation chamber 71B and can press-contact the first contact piece 421A between the inner surface of the second accommodation chamber 71B and the support 712 at the position of the protrusion 421C, thereby firmly holding the terminal 4 in the second accommodation chamber 71B.

Both ends of the accommodation chamber 71 in the connection direction X are not covered and are opened. The connection insertion portion 51B of the first connector 2 and the end 92 of the flexible substrate 9 can be inserted into the end of the accommodation chamber 71 on the first connector 2 side. The electric wire 10 extends from the end of the accommodation chamber 71 on the side opposite to the first connector 2. The second housing 7 has a partition 711 between the adjacent accommodation chambers 71 such that the terminals 4 adjacently disposed do not short-circuit.

A top surface 75A of a ceiling portion 75 of the second housing 7 has a protruding portion 72 and locked portions 73. The protruding portion 72 is a block-or plate-shaped portion protruding toward the first connector 2 and mates with the accommodation portion 55 of the first connector 2 to constitute a connection guide portion or an oblique connection suppression portion. In other words, the protruding portion 72 has such a size that it can be inserted into the accommodation portion 55 and is inserted into the accommodation portion 55 when the first connector 2 and the second connector 3 are connected. Therefore, the protruding portion 72 prevents oblique fitting of the first connector 2 and the second connector 3 and can properly connect the first connector 2 and the second connector 3. The protruding portion 72 is provided with a locking portion 74. The locking portion 74 is a portion used to lock the first connector 2 and the second connector 3 when they are connected and mates with the locked portion 56 of the first connector 2 to constitute a locking mechanism. The locking portion 74 is provided inside the protruding portion 72. In other words, the locking portion 74 is formed to be surrounded by the outer wall of the protruding portion 72 and protected by the protruding portion 72. An entry hole 72A is formed in the outer wall of the protruding portion 72 on the first connector 2 side. The entry hole 72A is a hole through which the locked portion 56 enters into the protruding portion 72 to connect the first connector 2 and the second connector 3. The locking portion 74 is an arm-shaped portion having a locking hole 74A capable of engaging with the protruding locked portion 56 and engages with the locked portion 56 when the first connector 2 and the second connector 3 are connected. The locked portion 73 is a portion that engages with a locking portion 83 of the second cover 8 and mates with the locking portion 83 to constitute a locking mechanism of the second housing 7 and the second cover 8. The locked portion 73 is a protrusion protruding from the top surface 75A. A plurality of locked portions 73 are provided in a manner spaced apart in the width direction Y, and three locked portions 73 are provided, for example.

The second cover 8 is attached to the second housing 7 from the connection direction X and holds the terminals 4 and the electric wires 10. For example, the second cover 8 is a plate-shaped member extending in the width direction Y. The second cover 8 is attached to the second housing 7 in which the terminals 4 and the electric wires 10 are accommodated and holds the terminals 4 and the electric wires 10. The second cover 8 has a ceiling portion 81 and an abutting portion 82. The ceiling portion 81 and the abutting portion 82 extend in the connection direction X side by side and are spaced apart in the height direction Z. The ceiling portion 81 and the abutting portion 82 are coupled on the side opposite to the side connected to the first connector 2, and the ceiling portion 81 is positioned above the abutting portion 82. The second cover 8 is attached to the second housing 7 such that the ceiling portion 75 of the second housing 7 is sandwiched between the ceiling portion 81 and the abutting portion 82.

The ceiling portion 81 has locking portions 83. The locking portion 83 is a portion that engages with the locked portion 73 of the second housing 7. The locking portion 83 extends from the ceiling portion 81 toward the second housing 7 along the connection direction X to form an arm shape and has an engagement hole 83A with which the locked portion 73 is engaged. A plurality of locking portions 83 are provided in a manner spaced apart in the width direction Y, and three locking portion 83 are provided, for example. The locking portion 83 engages with the locked portion 73 when the second cover 8 and the second housing 7 are attached and locks the second cover 8 and the second housing 7 such that they are not disengaged.

The abutting portion 82 is inserted into the second housing 7 when the second cover 8 and the second housing 7 are attached. The abutting portion 82 forms part of the accommodation chamber 71 and functions as the ceiling portion of the first accommodation chamber 71A. A plurality of partitions 821 are formed along the width direction Y on a bottom surface 82A of the abutting portion 82. The partition 821 is a portion that partitions between the adjacent accommodation chambers 71. The abutting portion 82 is disposed so as to abut the terminal 4 when the second cover 8 and the second housing 7 are attached (refer to FIG. 8). In other words, an end surface 82B of the abutting portion 82 supports the terminal 4 from behind and holds the terminal 4 such that the terminal 4 does not come off from the accommodation chamber 71.

As illustrated in FIG. 5, the terminal 4 is a terminal attached to the electric wire 10 and is a crimp terminal crimped onto the end of the electric wire 10, for example. The terminal 4 includes a wire connection portion 41 and a substrate connection portion 42. The terminal 4 is made of conductive metal, for example. The wire connection portion 41 and the substrate connection portion 42 are integrally formed by pressing or bending a plate material having a shape corresponding to the wire connection portion 41 and the substrate connection portion 42. In the terminal 4, the wire connection portion 41 and the substrate connection portion 42 are sequentially formed along the connection direction X. The electric wire 10 is made of a conductor 10A with a sheath 10B provided around its outer circumference, for example.

The wire connection portion 41 includes a sheath crimping portion 411 and a conductor crimping portion 412, for example. The sheath crimping portion 411 crimps the sheath 10B of the electric wire 10. For example, the sheath crimping portion 411 has two barrels 411A and is attached to the sheath 10B by wrapping the barrels 411A around the sheath 10B and crimping them. For example, the conductor crimping portion 412 has two barrels 412A and is attached to the conductor 10A by crimping the barrels 412A onto the conductor 10A exposed by removing the sheath 10B.

The substrate connection portion 42 is a portion that comes into contact with the flexible substrate 9 and has a pair of contact pieces 421. The pair of contact pieces 421 is composed of a first contact piece 421A and a second contact piece 421B. The substrate connection portion 42 is connected to the flexible substrate 9 by bringing the second contact piece 421B into direct contact with the flexible substrate 9, for example. The first contact piece 421A and the second contact piece 421B are plates or rods extending in the connection direction X. The first contact piece 421A and the second contact piece 421B are spaced apart in the height direction Z and coupled by a coupler 423 at the proximal end. In other words, the substrate connection portion 42 including the pair of contact pieces 421 serves as a tuning fork terminal with a bifurcate shape. The second contact piece 421B is elastically deformable by bending in the direction away from the first contact piece 421A (height direction Z). When being connected to the first connector 2, the flexible substrate 9 is inserted between the first contact piece 421A and the second contact piece 421B. During the insertion, the second contact piece 421B elastically deforms in the direction away from the first contact piece 421A, whereby the flexible substrate 9 is smoothly inserted. The second contact piece 421B then comes in strong contact with the flexible substrate 9 by the restoring force of elastic deformation. At this time, the first contact piece 421A functions as a load receiving portion that receives the contact load of the second contact piece 421B.

The axial direction B of the substrate connection portion 42 is misaligned in the height direction Z with respect to the axial direction A of the wire connection portion 41. In other words, the axial direction B in which the substrate connection portion 42 extends is misaligned in a direction intersecting the axial direction A with respect to the axial direction A in which the wire connection portion 41 extends. Therefore, the substrate connection portion 42 is formed protruding in the direction (height direction Z) intersecting the axial direction A with respect to the wire connection portion 41. The axial direction A of the wire connection portion 41 is the central axis of the wire connection portion 41, and the axial direction B of the substrate connection portion 42 is the central axis of the substrate connection portion 42. For example, the substrate connection portion 42 is formed such that the axial direction B protrudes to a position deviating from the wire connection portion 41.

The first contact piece 421A has the protrusion 421C protruding toward the second contact piece 421B. In other words, the protrusion 421C protrudes inward compared with the other part of the first contact piece 421A and narrows the distance between the first contact piece 421A and the second contact piece 421B. The protrusion 421C is formed at a position closer to the proximal end than the center position of the first contact piece 421A in the connection direction X, for example.

A contact portion 421D is formed at the distal end of the second contact piece 421B. The contact portion 421D protrudes toward the first contact piece 421A compared with the other part of the second contact piece 421B and narrows the distance between the first contact piece 421A and the second contact piece 421B. The contact portion 421D is a portion that comes into contact with the wiring portion 91 of the flexible substrate 9 and is formed in a chevron shape toward the first contact piece 421A, for example. While FIG. 5 illustrates the terminal 4 attached to the electric wire 10 by crimping, the terminal 4 may be attached to the electric wire 10 by a method other than crimping, such as pressure welding or soldering.

Next, the connection of the connector device 1 according to the present embodiment is described.

As illustrated in FIG. 6, the connection of the connector device 1 is made by connecting the first connector 2 and the second connector 3. The flexible substrate 9 is attached to the first connector 2, and the terminals 4 attached to the electric wires 10 are held in the second connector 3.

The first connector 2 and the second connector 3 are placed in a manner spaced apart in the connection direction X. The second connector 3, for example, is brought closer to the first connector 2 to make the connection. First, the protruding portion 72 of the second connector 3 is inserted into the accommodation portion 55 of the first connector 2. As illustrated in FIG. 7, the tapered portions 551 are formed at the entrance of the accommodation portion 55, and the opening width of the accommodation portion 55 is wider. Therefore, the protruding portion 72 is smoothly inserted into the accommodation portion 55 by the tapered portions 551.

The protruding portion 72 moves forward in the connection direction X along the wall 55B of the accommodation portion 55. As a result, the second connector 3 is prevented from being obliquely inserted into the first connector 2, thereby preventing oblique fitting of the second connector 3 and the first connector 2. When the protruding portion 72 is deeply inserted into the accommodation portion 55, the locked portion 56 enters into the protruding portion 72 and engages with the locking portion 74. As a result, the connection between the first connector 2 and the second connector 3 is locked.

As illustrated in FIG. 8, the first connector 2 and the second connector 3 are connected, whereby the connection insertion portion 51B of the first connector 2 and the flexible substrate 9 are inserted into the second housing 7 of the second connector 3. In other words, the connection insertion portion 51B and flexible substrate 9 are inserted into the accommodation chamber 71 of the second housing 7 and inserted between the first contact piece 421A and the second contact piece 421B of the terminal 4 held in the accommodation chamber 71. At this time, the space between the first contact piece 421A and the second contact piece 421B is widened by the insertion of the connection insertion portion 51B, and the second contact piece 421B bends away from the first contact piece 421A. As a result, the connection insertion portion 51B and the flexible substrate 9 can be smoothly inserted between the first contact piece 421A and the second contact piece 421B.

The pair of contact pieces 421 is pressed against and comes into contact with the wiring portion 91 of the flexible substrate 9, the flexible substrate 9 and the terminal 4 are connected, and the flexible substrate 9 and the electric wire 10 are electrically connected. As a result, the flexible substrate 9 and the electric wire 10 are connected via one terminal 4, and the connector device 1 can enhance the electrical performance of the flexible substrate 9 and the electric wire 10. In other words, the connector device 1 need not be provided with a terminal in the first connector 2 by using the flexible substrate 9 as a contact point and can reduce the number of physical contact points to two in the connection between the electric wire 10 and the flexible substrate 9. Therefore, the connector device 1 can reduce the risk of increased resistance and connection failure due to oxidation, wear, foreign matter, or the like at the contact points and improve the electrical performance of the flexible substrate 9 and the electric wire 10. In addition, the cost of the connector device 1 can be reduced because the connector device 1 need not be provided with a terminal in the first connector 2.

For example, if the first connector 2 is connected to the second connector 3 by providing a flexible substrate terminal to the flexible substrate 9, the number of components increases due to the installation of the flexible substrate terminal, and the cost is increased. In addition, the number of contact points is three in the connection between the flexible substrate 9 and the electric wire 10. In other words, electrical contact is made at three points: between the flexible substrate 9 and the flexible substrate terminal, between the flexible substrate terminal and the terminal 4, and between the terminal 4 and the electric wire 10. The increase in the number of contact points may cause increased resistance due to oxidation, wear, foreign matter, or the like at the contact points, and the electrical performance may possibly be deteriorated. By contrast, the connector device 1 and the terminal 4 according to the present embodiment need not be provided with a flexible substrate terminal and can reduce the number of contact points to two in the connection between the flexible substrate 9 and the electric wire 10. Therefore, the connector device 1 and the terminal 4 can improve the electrical performance in the connection between the flexible substrate 9 and the electric wire 10, and the cost can be reduced.

When the first connector 2 and the second connector 3 are connected, the flexible substrate 9 and the terminal 4 are securely connected in the second housing 7, thereby suppressing connection failure between the flexible substrate 9 and the terminal 4. For example, the substrate connection portion 42 of the terminal 4 is double-locked by the support 712 and the abutting portion 82 in the second housing 7. Specifically, the first contact piece 421A of the terminal 4 is press-fit between the inner surface of the second accommodation chamber 71B and the support 712 when inserted into the second accommodation chamber 71B. Therefore, the terminal 4 is firmly engaged with and held by the second housing 7. The substrate connection portion 42 of the terminal 4 protrudes in the height direction z with respect to the wire connection portion 41, and the abutting portion 82 abuts on the substrate connection portion 42 from the rear side (electric wire 10 side). Thus, the terminal 4 is firmly engaged with and held by the second housing 7 against force to pull it out from the electric wire 10 side. Therefore, if force in the pulling direction is applied to the electric wire 10, the terminal 4 is prevented from being pulled out. If force in the pulling direction is applied to the electric wire 10, the pulling force is hardly transmitted between the flexible substrate 9 and the contact portion 421D, and the connector device 1 can stabilize the connection between the terminal 4 and the flexible substrate 9. If the connector device 1 is used as a wire harness WH, it is assumed that pulling force is applied to the electric wire 10 when routing the wire harness WH, for example. In such a case, the connector device 1 can prevent the connection between the flexible substrate 9 and the terminal 4 from being released or becoming unstable because the terminal 4 is firmly engaged with and held by the second housing 7.

As described above, the connector device 1 according to the present embodiment is provided with the protruding portion 72 and the accommodation portion 55. Therefore, the connector device 1 can prevent the first connector 2 and the second connector 3 from being obliquely fit and properly connect the first connector 2 and the second connector 3. The connector device 1 according to the present embodiment has the tapered portion 551, thereby enabling smooth connection between the first connector 2 and the second connector 3.

The connector device 1 according to the present embodiment brings the terminal 4 into direct contact with the wiring portion 91 of the flexible substrate 9 by the connection between the first connector 2 and the second connector 3. With this structure, the connector device 1 according to the present embodiment can accurately connect the first connector 2 and the second connector 3 with the protruding portion 72 and the accommodation portion 55 and accurately bring the terminal 4 in contact with the wiring portion 91 of the flexible substrate 9.

The connector device 1 according to the present embodiment includes the terminal 4 having a pair of contact pieces 421. Therefore, the terminal 4 can allow the flexible substrate 9 to be inserted between the pair of contact pieces 421 and bring the pair of contact pieces 421 into contact with the wiring portion 91 of the flexible substrate 9.

The connector device 1 according to the present embodiment has the locking portion 74 formed inside the protruding portion 72 and the locked portion 56 formed inside the accommodation portion 55. Therefore, the locking portion 74 and the locked portion 56 can be protected by the protruding portion 72 and the accommodation portion 55.

The connector device according to the present invention is not limited to the embodiment described above, and various modifications can be made within the scope of the claims. The connector device 1 according to the present embodiment may be configured by appropriately combining the components of the embodiments and modifications described above.

While the connector device 1 according to the embodiment described above is mounted on a vehicle, for example, it may be used without being mounted on a vehicle.

While the connector device 1 according to the embodiment described above includes the flexible substrate 9 as a flat circuit body, a flat circuit body other than the flexible substrate 9 may be used. For example, a flat cable (FC) or a flexible flat cable (FFC) may be used as the flat circuit body and connected to the terminal 4. Such a connector device can also have the same advantageous effects as the connector device 1 according to the embodiment described above. In other words, with the protruding portion 72 and the accommodation portion 55, the connector device can prevent the first connector 2 and the second connector 3 from being obliquely fit and properly connect the first connector 2 and the second connector 3. The connector device has the tapered portion 551, thereby enabling smooth connection between the first connector 2 and the second connector 3.

While the connector device 1 according to the embodiment described above has the tapered portion 551 in the accommodation portion 55 of the first connector 2, a tapered portion may be formed in the protruding portion 72 of the second connector 3. For example, the corners of the protruding portion 72 in the insertion direction may be chamfered such that the protruding portion 72 tapers toward the insertion direction. With this configuration, the length of the accommodation portion 55 in the width direction Y is larger than that of the protruding portion 72 in the width direction Y at the entrance position of the accommodation portion 55, and the same advantageous effects can be provided as in the connector device 1 according to the embodiment described above. In other words, the protruding portion 72 is easily inserted into the accommodation portion 55, and the first connector 2 and the second connector 3 can be smoothly connected. The tapered portion 551 may be formed in both the accommodation portion 55 of the first connector 2 and the protruding portion 72 of the second connector 3. Such a connector device can also have the same advantageous effects as the connector device 1 according to the embodiment described above, facilitates insertion of the protruding portion 72 into the accommodation portion 55, and enables smooth connection between the first connector and the second connector.

While the first connector 2 has the accommodation portion 55, and the second connector 3 has the protruding portion 72 in the connector device 1 according to the embodiment described above, the first connector 2 may have the protruding portion 72, and the second connector 3 may have the accommodation portion 55. Also in this case, the same advantageous effects can be provided as in the connector device 1 according to the embodiment described above.

While the terminal 4 of the second connector 3 is brought in direct contact with the flexible substrate 9 of the first connector 2 in the connector device 1 according to the embodiment described above, the terminal 4 and the flexible substrate 9 may not be in direct contact. Also in this case, if the connector device is provided with the protruding portion 72 and the accommodation portion 55, it enables proper and smooth connection between the first connector 2 and the second connector 3 as in the connector device 1 according to the present embodiment.

While the terminal 4 has the pair of contact pieces 421 in the connector device 1 according to the embodiment described above, a terminal not having the pair of contact pieces 421 may be used. Also in this case, if the connector device is provided with the protruding portion 72 and the accommodation portion 55, it enables proper and smooth connection between the first connector 2 and the second connector 3 as in the connector device 1 according to the present embodiment.

While the locking portion 74 is provided inside the protruding portion 72, and the locked portion 56 is provided inside the accommodation portion 55 in the connector device 1 according to the embodiment described above, the locking portion 74 may be provided inside the accommodation portion 55, and the locked portion 56 may be provided inside the protruding portion 72. Such a connector device can protect the locking portion 74 and the locked portion 56 by the protruding portion 72 and the accommodation portion 55 as in the connector device 1 according to the embodiment described above.

The connector device according to the present embodiment enables proper and smooth connection between a flat circuit body and an electric wire.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector device comprising:
a first connector that has a first housing attached to a flat circuit body; and
a second connector that has a second housing held a plurality of terminals along a width direction attached to a plurality of electric wires, holds the plurality of terminals, configured to be connectable to the first connector, and connected to the first connector to connect the electric wires and the flat circuit body via the terminals, wherein
one of the first connector and the second connector has a protruding portion protruding and extending from one of the first housing and the second housing in a connection direction between the first connector and the second connector,
an other of the first connector and the second connector has an accommodation portion into which the protruding portion is capable of being inserted and accommodated and that guides connection between the first connector and the second connector by insertion of the protruding portion,
the protruding portion is provided at a center position in a width direction of the one of the first housing and the second housing,
the accommodation portion is provided at a center position in a width direction of an other of the first housing and the second housing, and
at least one of the protruding portion and the accommodation portion has a tapered portion that tapers toward an inner side of the accommodation portion.

2. The connector device according to claim 1, wherein
the terminals come into direct contact with the flat circuit body by connection between the first connector and the second connector.

3. The connector device according to claim 2, wherein
the terminals each have a pair of contact pieces, and the flat circuit body is inserted between the pair of contact pieces to bring the pair of contact pieces into direct contact with the flat circuit body.

4. The connector device according to claim 1, wherein
a locking portion is formed so as to be surrounded by one of a wall forming the protruding portion and a wall forming the accommodation portion,
a locked portion that engages with the locking portion is formed so as to be surrounded by an other of the wall forming the protruding portion and the wall forming the accommodation portion, and
the locking portion and the locked portion engage when the first connector and the second connector are connected and cause the first connector and the second connector to engage.

5. The connector device according to claim 2, wherein
a locking portion is formed so as to be surrounded by one of a wall forming the protruding portion and a wall forming the accommodation portion,
a locked portion that engages with the locking portion is formed so as to be surrounded by an other of the wall forming the protruding portion and the wall forming the accommodation portion, and
the locking portion and the locked portion engage when the first connector and the second connector are connected and cause the first connector and the second connector to engage.

6. The connector device according to claim 1, wherein
the flat circuit body is a flexible substrate.

7. The connector device according to claim 2, wherein
the flat circuit body is a flexible substrate.

8. The connector device according to claim 3, wherein
the flat circuit body is a flexible substrate.
